(19) United States
(12) Patent Application Publication
(10) Pub. No.: US 2026/0339977 A1
(43) Pub. Date: Oct. 29, 2026

(54) LINKING DATA SYSTEM TO EXTERNAL CATALOG

(71) Applicant: Snowflake Inc., Bozeman, MT (US)

(72) Inventors: Naga Venkata Dharma Teja Anne, Sammamish, WA (US); Hung-An Chen, Seattle, WA (US); Michael Collado, Seattle, WA (US); Dennis Huo, Newcastle, WA (US); Ronald Lee Ortloff, Sammamish, WA (US); Maninderjit Singh Parmar, Kirkland, WA (US); Polita Paulus, Kirkland, WA (US); Saurin Shah, Kirkland, WA (US); Nileema Shingte, San Mateo, CA (US); Jeemin Sim, Seattle, WA (US); Ruobing Wang, East Brunswick, NJ (US); Di Fei Zhang, Redmond, WA (US)

(21) Appl. No.: 19/186,999

(22) Filed: Apr. 23, 2025

(51) Int. Cl. G06F 16/27; G06F 16/21; G06F 16/22

(52) U.S. Cl. CPC G06F 16/27; G06F 16/211; G06F 16/2282

(57) ABSTRACT

Various example embodiments described herein provide for systems, methods, devices, instructions, and the like for linking a data system, such as a database system, to a catalog external to the data system. In particular, some example embodiments provide a catalog linked database (CLD) that enables automatic synchronization between a database system and an external catalog that is external to the database system.

### TECHNICAL FIELD

Embodiments described herein relate to data systems and, more particularly, to systems, methods, devices, and instructions for linking a data system, such as a database system, to a catalog external to the data system.

### BACKGROUND

Databases are widely used for data storage and access in computing applications. A goal of database storage is to provide enormous sums of information in an organized manner so that it can be accessed, managed, updated, and shared. Data may be organized into rows, columns, and tables in a database. Different database storage systems may be used to store different types of content, such as bibliographic, full text, numeric, and image content. Further, in computing, different database systems may be classified according to the organizational approach of the database. There are many different types of databases, including relational, distributed, cloud, object-oriented, and others.

Databases may include one or more tables that include or reference data that can be joined, read, modified, or deleted using queries. Databases can store small or large sets of data within one or more tables. This data can be accessed by various users in an organization or even be used to service public users, such as via a website or an application programming interface (API).

### BRIEF DESCRIPTION THE DRAWINGS

Various ones of the appended drawings merely illustrate various example embodiments of the present disclosure and should not be considered as limiting its scope. In the drawings, which are not necessarily drawn to scale, like numerals may describe similar components in different views. To easily identify the discussion of any particular element or act, the most significant digit or digits in a reference number refer to the figure number in which that element is first introduced.

FIG. 1 illustrates an example computing environment comprising a database system in the example form of a network-based database system that includes a catalog link database component, according to some example embodiments of the present disclosure.

FIG. 2 is a block diagram illustrating components of a compute service manager, according to some example embodiments of the present disclosure.

FIG. 3 is a block diagram illustrating components of an execution platform, according to some example embodiments of the present disclosure.

FIG. 4 is a flowchart of an example method for linking a data system to a catalog external to the data system, according to some example embodiments of the present disclosure.

FIG. 5 is a diagram illustrating an example of linking and synchronizing of an external catalog and a database system, according to some example embodiments of the present disclosure.

FIG. 6 is a hierarchical diagram illustrating an example namespace and table structure within an example external catalog, according to some example embodiments of the present disclosure.

FIG. 7 illustrates a diagrammatic representation of a machine in the form of a computer system within which a set of instructions can be executed for causing the machine to perform any one or more of the methodologies discussed herein, according to some example embodiments of the present disclosure.

### DETAILED DESCRIPTION

Reference will now be made in detail to specific embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Apache Iceberg™ is a specification describing an open-source software (OSS) table format that provides capabilities for managing large analytic datasets. In particular, the table format defined by the Apache Iceberg™ specification enables consistent data access across various computing engines and platforms and allows a data engineer to manage table-like datasets stored in Apache Parquet™ files on blob storage. A table having a table format provided by Apache Iceberg™ can be referred to herein as an Iceberg table. Generally, the open-table format of Apache Iceberg™ allows a database system to operate on the data stored in an Iceberg table in a transactionally consistent way, without contacting a database or copying data from a database. An Iceberg table can include three components: the data (e.g., stored in Apache Parquet™ format or another format), metadata (e.g., which represents what part of the data is in a certain snapshot), and a catalog.

As used herein, a catalog can comprise a data management structure configured as a single pane used to determine which tables (e.g., Iceberg tables) of a database are the latest snapshots that can be queried, what data is committed or can be committed to a table (e.g., Iceberg table) of a database, or discover data assets that are available via a table (e.g., an Iceberg table) of a database. Tasks such as creating, dropping, and renaming tables are the functionalities associated with a catalog. In this regard, the catalog can provide a single pane to manage a collection of tables grouped into one or more namespaces, including discovering available tables, discovering and managing their metadata, and being the authority on tracking and committing table snapshots (or versions).

Traditional database systems typically operate with their own internal catalogs, which store metadata about tables, schemas, and other database objects. When working with external catalogs, data (e.g., database) systems face challenges related to metadata synchronization, schema compatibility, and maintaining consistent views of data across environments. The proliferation of data lake architectures has introduced additional complexity, as different query engines (e.g., Spark, Trino, and Flink) can interact with the same underlying data but maintain separate catalog representations. This model difference can create obstacles to seamless interoperability between systems. Maintaining consistency between different catalog representations presents technical challenges, particularly when tables are added, modified, or removed in one environment but not automatically reflected in others.

Various example embodiments described herein provide for systems, methods, devices, instructions, and the like for linking a data system, such as a database system, to a catalog external to (e.g., external to and remote from) the data system. In particular, some example embodiments provide a catalog linked database (CLD) that enables automatic synchronization between a database system and an external catalog (e.g., external Apache Iceberg™ catalog, such as an Iceberg REST catalog) that is external to the database system. For some example embodiments, the external catalog is hosted on a system (e.g., another database system) that is external to and remote from the database system, where the remote external system manages the external catalog. Use of various example embodiments address a challenge of a database system accessing and managing data that exists across one or more catalogs that are external to the database system.

According to some example embodiments, a CLD comprises a special type of database that connects to an external catalog. A CLD can be identified by a database flag, which can be checked by a database system using a method or function (e.g., a database.isCatalogLinkedDatabase( ) method). The flag can distinguish a CLD from a database that is not a CLD and can enable specific functionality for external catalog integration. Various example embodiments use an auto table discovery (ATD) process of a database system to implement or otherwise support CLDs on the database system. When a user generates (e.g., creates) a CLD on a database system in association with an external catalog (thereby linking the CLD to the external catalog), an auto table discovery process can be automatically scheduled for the CLD, where the auto table discovery process can synchronize tables of the CLD with tables of the external catalog. In particular, the auto table discovery process can determine one or more differences between CLD and the external catalog and, based on the one or more differences, can add to the CLD any tables of the external catalog that are missing from the CLD, can remove (e.g., drop) from the CLD any tables that have been removed (e.g., dropped) from the external catalog, or can alter (e.g., rename) one or more tables of the CLD based on one or more changes applied to one or more corresponding tables of the external catalog. According to various example embodiments, tables of the CLD comprise Apache Iceberg™ tables, which can be enabled to or configured to auto-refresh (e.g., a periodic basis) data associated the Apache Iceberg™ tables (e.g., metadata) with data (e.g., metadata) associated with the external catalog. For some example embodiments, the external catalog comprises an Apache Iceberg™ catalog, which can comprise one or more Apache Iceberg™ tables.

For various example embodiments, the auto table discovery process comprises obtaining, from the external catalog, a list of namespaces of the external catalog, a list of tables of the external catalog, or both. For instance, the auto table discovery process can call one or more APIs (e.g., Apache Iceberg™ APIs) associated with the external catalog to obtain the list of namespaces of the external catalog (e.g., listNamespaces API) and to obtain the list of tables of the external catalog (e.g., listTables API). By obtaining the list of namespaces of the external catalog, the list of tables of the external catalog, or both, various example embodiments can obtain a current snapshot (e.g., of namespaces, tables, or both) of the external catalog. For some example embodiments, the auto table discovery process comprises determines (e.g., identifies) one or more tables of the CLD, and compares the determined one or more tables and the current snapshot of the external catalog (e.g., listing of namespaces and listing of tables of the external catalog) to determine one or more differences between the CLD and the external catalog. In this way, the auto table discovery process can determine which tables exist in the external catalog but not in the CLD. For each individual table that exists in the external catalog but not in the CLD, the auto table discovery process can generate (e.g., add or create) a corresponding schema (e.g., namespace associated with the individual table) and can generate or schedule generation (e.g., creation) of the table (e.g., schedule SyncMissingTablesFromCatalogTask to generate the table). An individual table generated in (e.g., created in or added to) the CLD can comprise an Iceberg table (e.g., unmanaged Iceberg table). Additionally, to facilitate access to the external catalog, various example embodiments use a catalog integration and external volume on the database system, where the catalog integration and external volume can be provided on (or as part of) the CLD. Where the catalog integration for the external catalog has VENDED_CREDENTIALS access mode, a table can be created via vended credentials.

For various example embodiments, after a CLD is generated (e.g., created) on a database system and an auto table discovery process has been initially performed for the CLD, the database system causes the auto table discovery process to be performed (e.g., run) on a scheduled basis. For instance, the auto table discovery process can be run on a polling basis (e.g., 5 minute polling interval), where a next performance (e.g., next run) of the auto table discovery process can be scheduled based on a scheduled delay. Depending on the example embodiment, the CLD of the database system can handle nested namespaces by flattening nested namespaces (e.g., nested namespaces can be concatenated with a user-provided delimiter, such as “.” or “/” or “_” or “$”).

To facilitate table identification and table alteration (e.g., rename) detection, the data system can use a unique table identifier associated with an individual table (e.g., of an external catalog), where metadata associated with the individual table can store (e.g., provide) the unique table identifier of the individual table. For instance, a table-uuid field of metadata (e.g., JSON file) associated with an individual table can uniquely identify the individual table. Each table (e.g., each Iceberg table) of the external catalog can be uniquely identified by a unique table identifier (e.g., table-uuid). Some example embodiments use unique table identifiers to track tables (e.g., of the external catalog) even if they are renamed or recreated.

Depending on the example embodiment, a CLD of a database system can implement bi-directional synchronization, where changes made in the CLD (e.g., to a table of the CLD or to data stored in a table of the CLD) are reflected (e.g., synched) to an external catalog (e.g., external catalog on a remote, external database system) associated with the CLD. Alternatively, a CLD of a database system can be read-only, where changes made in the CLD are not reflected (e.g., synched to) an external catalog (e.g., external catalog on a remote, external database system) associated with the CLD.

Access control implemented for CLDs can be similar to the access control used for non-catalog catalog linked databases. For instance, only users with roles having CREATE DATABASE privilege can create a CLD. Schemas and tables automatically created under the CLD (e.g., by the auto table discovery process of various example embodiments) can be owned by a role having OWNERSHIP on the CLD. Database roles in a CLD can inherit the same access control model as those in a non-catalog catalog linked database.

Overall, a CLD provided by various example embodiments enable a database system to easily mirror tables (e.g., Iceberg tables) in a remote external catalog (e.g., remote external Iceberg catalog), which can help obviate the need for a user to manually create corresponding tables (e.g., corresponding Iceberg tables) on the database system to mirror the remote external catalog. Accordingly, a CLD of various example embodiments can provide a seamless way for a database system to access and query data stored in an external catalog without having to manually create and maintain individual table references, and without having to handle the complexities of different naming conventions, nested namespaces, and credential management.

Though various example embodiments are described herein with respect to external catalogs, a CLD of some example embodiments can be used to map to another remote metadata system (e.g., remote database) or another table format. For example, though various example embodiments are described herein with respect to Apache Iceberg™ (e.g., tables and catalogs in accordance with a version of an Apache Iceberg™ specification), it will be understood that some example embodiments are implemented based on or using an additional or alternative data structure (e.g., table format) specification. For instance, an example embodiment described herein can be implemented with respect to an Apache Hudi, a Delta Lake, or a Cassandra™ specification. A system of some example embodiments comprises a connector that transforms data (e.g., kafka topics or Cassandra tables) into data compatible for use through a CLD. Additionally, a system of some example embodiments can crawl a remote metadata system and use a polling or notification mechanism to indicate when tables are created, dropped, or renamed.

Table 1 presents an example of a command for generating (e.g., creating) a catalog integration named ‘cat_polaris’ on a database system for an individual external catalog (e.g., hosted on a remote external system) named ‘POLARIS’ that facilitates the database system's access (e.g., authenticated access) of the individual external catalog. According to various example embodiments, after the catalog integration is generated, a CLD for the individual external catalog can be created on the database system as described herein.

TABLE 1
CREATE CATALOG INTEGRATION cat_polaris
CATALOG_SOURCE = POLARIS
TABLE_FORMAT = ICEBERG
REST_CONFIG = (
CATALOG_URI = ‘<open_catalog_account_url>’
CATALOG_NAME = ‘<open_catalog_catalog_name>’ -- catalog name
in the remote catalog.
ACCESS_DELEGATION_MODE = VENDED_CREDENTIALS
)
REST_AUTHENTICATION = (
TYPE = OAUTH
OAUTH_CLIENT_ID = ‘<oauth_client_id>’
OAUTH_CLIENT_SECRET = ‘<oauth_client_secret>’
OAUTH_ALLOWED_SCOPES = (‘<scope 1>’, ‘<scope 2>’)
)
ENABLED = { TRUE | FALSE }
[ REFRESH_INTERVAL_SECONDS = <value> ] --this is for auto-
refresh
[ COMMENT = ‘<string_literal>’ ]
;

Overall, a data description language (DDL) for generating (e.g., creating) a catalog linked database can extend from the CREATE DATABASE command with new options. For example, the LINKED_CATALOG option can specify the catalog integration on which the CLD depends, and the EXTERNAL_VOLUME option can specify an external volume if the catalog integration does not have credential vending enabled.

Table 2 presents an example of a command for generating (e.g., creating) a catalog linked database (CLD) named ‘my_linked_db’ on a database system for an individual external catalog (e.g., hosted on a remote external system) using a catalog integration ‘my_catalog_int’ and an external volume ‘my_external vol.’

TABLE 2

CREATE DATABASE my_linked_db
LINKED_CATALOG = (
CATALOG = ‘my_catalog_int’,
),
EXTERNAL_VOLUME = ‘my_external_vol’;

Table 3 presents an alternative example of a command for generating (e.g., creating) a CLD named ‘my_linked_db’ on a database system for an individual external catalog using vended credentials (e.g., my_catalog_int_veneded_creds) and a specified allowed namespace ‘my_namespace.’ In some example embodiments, the ALLOWED_NAMESPACES parameter can be used to limit the scope of the auto table discovery process to a particular namespace in the individual external catalog.

TABLE 3
CREATE DATABASE my_linked_db
LINKED_CATALOG = (
CATALOG = ‘my_catalog_int_vended_creds’, ALLOWED_NAMESPACES =
(‘my_namespace’)
);

Table 4 presents an alternative example of a command for generating (e.g., creating) a CLD named ‘cat_linked_db’ on a database system for an individual external catalog using the catalog integration ‘cat_polaris’ generated by the command of Table 1.

```
TABLE 4
CREATE DATABASE cat_linked_db
  LINKED_CATALOG = (
    CATALOG = cat_polaris
    [ ALLOWED_NAMESPACES = (<value>) ] -- filter on
namespaces
    NAMESPACE_MODE = IGNORE_NESTED_NAMESPACE |
FLATTEN_NESTED_NAMESPACE
    [ NAMESPACE_FLATTEN_DELIMITER ] = <delimiter of choi
ce> -- required if NAMESPACE_MODE = FLATTEN_NESTED_NAMESPACE
)
EXTERNAL_VOLUME = <exvol_name> -
- optional if catalog provides vended credentials
;
```

Table 5 presents an example of a command for checking the synchronization status of a CLD named ‘my_linked_db.’ In particular, after a user creates a CLD on a database system, the user can use the SYSTEM$CATALOG_LINK_STATUS function to check if the database system has successfully linked to an external catalog associated with the CLD.

TABLE 5
SELECT SYSTEM $ CATALOG_LINK_STATUS ( ‘my_linked_db’ );

Table 6 presents an example of commands for pausing and resuming synchronization between a CLD specified by <name> and an external catalog associated with the CLD.

TABLE 6

-- resume
ALTER DATABASE <name> RESUME_CATALOG_SYNC;
-- pause
ALTER DATABASE <name> PAUSE_CATALOG_SYNC;

Table 7 presents an example of querying a CLD named ‘my_linked_db’ on a database system.

TABLE 7
USE DATABASE my_linked_db;
SELECT * FROM my_namespace . my_iceberg_table LIMIT 20;

As used herein, a table can comprise a data structure comprising one or more rows (e.g., mutable rows) that store data.

As used herein, a data lake can comprise a centralized repository designed to store large volumes of data in its original, raw format, without requiring predefined structures or schemas. A data lake can accommodate diverse types of data, including structured data (e.g., relational databases), semi-structured data (e.g., JSON, XML), unstructured data (e.g., text documents, images, audio, video), and binary data. Data is ingested from various sources and stored in a flat architecture using object storage, enabling metadata tagging and efficient retrieval. By consolidating all data types in a data lake, the data lake can eliminate data silos and provide flexibility for querying and analyzing data across multiple applications.

Reference will now be made in detail to various example embodiments of the present disclosure, examples of which are illustrated in the appended drawings. The present disclosure may, however, be embodied in many different forms and should not be construed as being limited to the examples set forth herein.

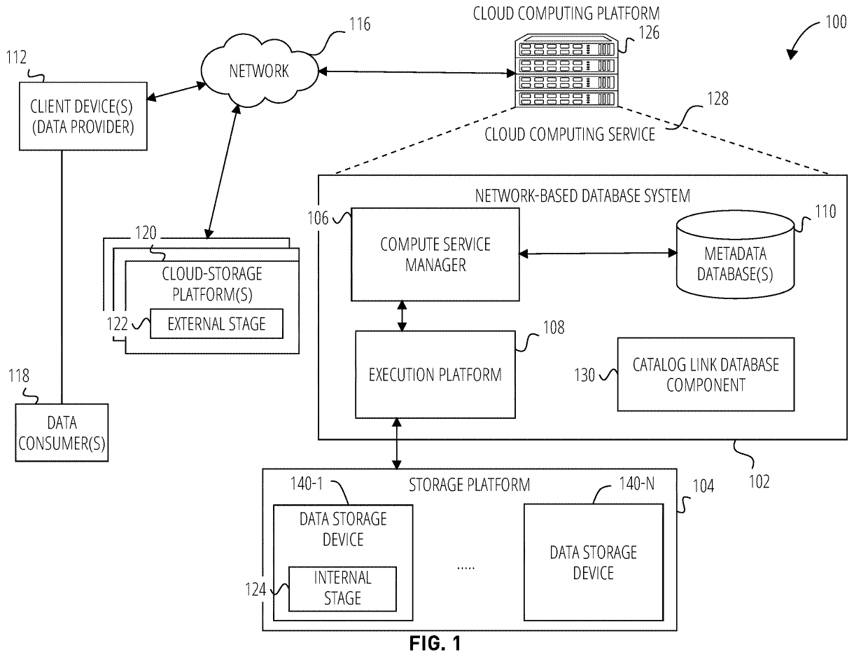

FIG. 1 illustrates an example computing environment 100 comprising a database system in the example form of a network-based database system 102 that includes a catalog link database component 130, according to some example embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other example embodiments, the computing environment may comprise another type of network-based database system or a cloud data platform. For example, in some example embodiments, the computing environment 100 may include a cloud computing platform 126 with the network-based database system 102, and a storage platform 104 (also referred to as a cloud storage platform). The cloud computing platform 126 provides computing resources and storage resources that may be acquired (purchased) or leased and configured to execute applications and store data.

The cloud computing platform 126 may host a cloud computing service 128 that facilitates storage of data on the cloud computing platform 126 (e.g., data management and access) and analysis functions (e.g., SQL queries, analysis), as well as other processing capabilities (e.g., configuring replication group objects as described herein). The cloud computing platform 126 may include a three-tier architecture: data storage (e.g., storage platforms 104), an execution platform 108 (e.g., providing query processing), and a compute service manager 106 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURER, GOOGLE CLOUD PLATFORM™ and/or the like. The customer's servers and cloud-storage platforms are both examples of what a given customer could use as what is referred to herein as an external storage location. The cloud computing platform 126 could also use a cloud-storage platform as what is referred to herein as an internal storage location concerning the data platform.

From the perspective of the network-based database system 102 of the cloud computing platform 126, one or more files that are stored at one or more storage locations are referred to herein as being organized into one or more of what is referred to herein as either “internal stages” or “external stages.” Internal stages (e.g., internal stage 124) are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 126 is in communication with the storage platforms 104 and cloud-storage platforms 120 (e.g., AWS®, Microsoft Azure Blob Storage®, or Google Cloud Storage). The network-based database system 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the network-based database system 102.

The network-based database system 102 comprises a compute service manager 106, an execution platform 108, and one or more metadata databases 110. The network-based database system 102 hosts and provides data reporting and analysis services to multiple client accounts.

The compute service manager 106 coordinates and manages operations of the network-based database system 102. The compute service manager 106 also performs query optimization and compilation as well as managing clusters of computing services that provide compute resources (also referred to as “virtual warehouses”). The compute service manager 106 can support any number of client accounts such as end-users providing data storage and retrieval requests, system administrators managing the systems and methods described herein, and other components/devices that interact with compute service manager 106.

The compute service manager 106 is also in communication with a client device 112. The client device 112 corresponds to a user of one of the multiple client accounts supported by the network-based database system 102. A user may utilize the client device 112 to submit data storage, retrieval, and analysis requests to the compute service manager 106. Client device 112 (also referred to as remote computing device or user client device 112) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 126 (e.g., cloud computing service 128) by way of a network 116, such as the Internet or a private network. A data consumer 118 can use another computing device to access the data of the data provider (e.g., data obtained via the client device 112).

In the description below, actions are ascribed to users, particularly consumers and providers. Such actions shall be understood to be performed concerning client device (or devices) 112 operated by such users. For example, a notification to a user may be understood to be a notification transmitted to the client device 112, input or instruction from a user may be understood to be received by way of the client device 112, and interaction with an interface by a user shall be understood to be interaction with the interface on the client device 112. In addition, database operations (joining, aggregating, analysis, etc.) ascribed to a user (consumer or provider) shall be understood to include performing such actions by the cloud computing service 128 in response to an instruction from that user.

The compute service manager 106 is also coupled to one or more metadata databases 110 that store metadata about various functions and aspects associated with the network-based database system 102 and its users. For example, a metadata database 110 may include a summary of data stored in remote data storage systems as well as data available from a local cache. Additionally, a metadata database 110 may include information regarding how data is organized in remote data storage systems (e.g., the cloud storage platform 104) and the local caches. Information stored by a metadata database 110 allows systems and services to determine whether a piece of data needs to be accessed without loading or accessing the actual data from a storage device. In some example embodiments, metadata database 110 is configured to store account object metadata (e.g., account objects used in connection with a replication group object).

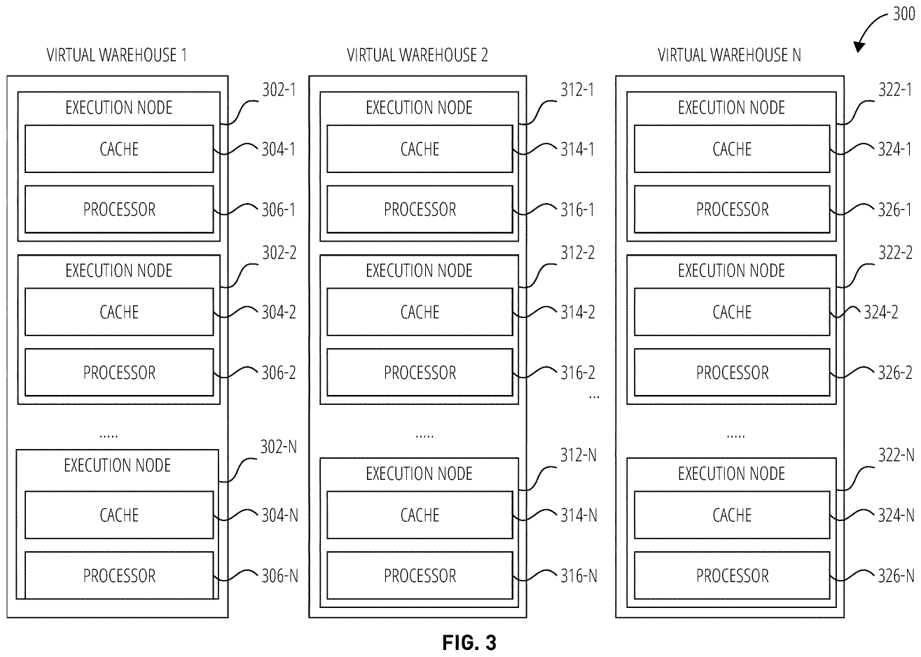

The compute service manager 106 is further coupled to the execution platform 108, which provides multiple computing resources that execute various data storage and data retrieval tasks. As illustrated in FIG. 3, the execution platform 108 comprises a plurality of compute nodes. The execution platform 108 is coupled to storage platform 104 and cloud-storage platforms 120. The storage platform 104 comprises multiple data storage devices 140-1 to 140-N. In some example embodiments, the data storage devices 140-1 to 140-N are cloud-based storage devices located in one or more geographic locations. For example, the data storage devices 140-1 to 140-N may be part of a public cloud infrastructure or a private cloud infrastructure. The data storage devices 140-1 to 140-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some example embodiments, at least one internal stage 124 may reside on one or more of the data storage devices 140-1-140-N, and at least one external stage 122 may reside on one or more of the cloud-storage platforms 120.

In some example embodiments, communication links between elements of the computing environment 100 are implemented via one or more data communication networks. These data communication networks may utilize any communication protocol and any type of communication medium. In some example embodiments, the data communication networks are a combination of two or more data communication networks (or sub-networks) coupled to one another. In alternative embodiments, these communication links are implemented using any type of communication medium and any communication protocol.

The compute service manager 106, metadata database(s) 110, execution platform 108, and storage platform 104, are shown in FIG. 1 as individual discrete components. However, each of the compute service manager 106, metadata database(s) 110, execution platform 108, and storage platform 104 may be implemented as a distributed system (e.g., distributed across multiple systems/platforms at multiple geographic locations). Additionally, each of the compute service manager 106, metadata database(s) 110, execution platform 108, and storage platform 104 can be scaled up or down (independently of one another) depending on changes to the requests received and the changing needs of the network-based database system 102. Thus, in the described example embodiments, the network-based database system 102 is dynamic and supports regular changes to meet the current data processing needs.

During a typical operation, the network-based database system 102 processes multiple jobs determined by the compute service manager 106. These jobs are scheduled and managed by the compute service manager 106 to determine when and how to execute the job. For example, the compute service manager 106 may divide the job into multiple discrete tasks and may determine what data is needed to execute each of the multiple discrete tasks. The compute service manager 106 may assign each of the multiple discrete tasks to one or more nodes of the execution platform 108 to process the task. The compute service manager 106 may determine what data is needed to process a task and further determine which nodes within the execution platform 108 are best suited to process the task. Some nodes may have already cached the data needed to process the task and, therefore, be a good candidate for processing the task. Metadata stored in a metadata database 110 assists the compute service manager 106 in determining which nodes in the execution platform 108 have already cached at least a portion of the data needed to process the task. One or more nodes in the execution platform 108 process the task using data cached by the nodes and, if necessary, data retrieved from the storage platform 104. It is desirable to retrieve as much data as possible from caches within the execution platform 108 because the retrieval speed is typically much faster than retrieving data from the storage platform 104.

As shown in FIG. 1, the cloud computing platform 126 of the computing environment 100 separates the execution platform 108 from the storage platform 104. In this arrangement, the processing resources and cache resources in the execution platform 108 operate independently of the data storage devices 140-1 to 140-N in the storage platform 104. Thus, the computing resources and cache resources are not restricted to specific data storage devices 140-1 to 140-N. Instead, all computing resources and all cache resources may retrieve data from, and store data to, any of the data storage resources in the storage platform 104.

As also shown, the network-based database system 102 comprises catalog link database component 130, which can enable or otherwise facilitate the linking of the network-based database system 102 to a catalog external to the network-based database system 102 (e.g., catalog hosted on a system external to the network-based database system 102, such as another network-based database system not shown in FIG. 1) as described herein.

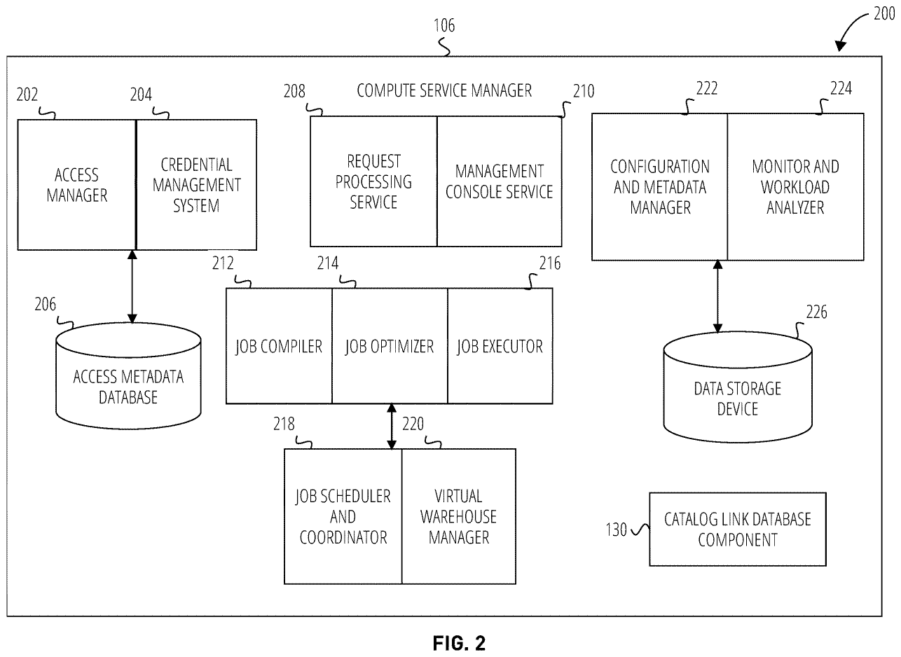

FIG. 2 is a block diagram 200 illustrating components of the compute service manager 106, according to some example embodiments of the present disclosure. As shown in FIG. 2, the compute service manager 106 includes an access manager 202 and a credential management system 204 coupled to access metadata database 206, which is an example of the metadata database(s) 110.

Access manager 202 handles authentication and authorization tasks for the systems described herein. The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data can be stored in a cache within the execution platform 108 or in a data storage device in storage platform 104.

A management console service 210 supports access to various systems and processes by administrators and other system managers. Additionally, the management console service 210 may receive a request to execute a job and monitor the workload on the system.

The compute service manager 106 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 106.

A job scheduler and coordinator 218 sends received jobs to the appropriate services or systems for compilation, optimization, and dispatch to the execution platform 108. For example, jobs can be prioritized and then processed in that prioritized order. In an embodiment, the job scheduler and coordinator 218 determines a priority for internal jobs that are scheduled by the compute service manager 106 with other “outside” jobs such as user queries that can be scheduled by other systems in the database but may utilize the same processing resources in the execution platform 108. In some example embodiments, the job scheduler and coordinator 218 identifies or assigns particular nodes in the execution platform 108 to process particular tasks. A virtual warehouse manager 220 manages the operation of multiple virtual warehouses implemented in the execution platform 108. For example, the virtual warehouse manager 220 may generate query plans for executing received queries.

Additionally, the compute service manager 106 includes a configuration and metadata manager 222, which manages the information related to the data stored in the remote data storage devices and in the local buffers (e.g., the buffers in execution platform 108). The configuration and metadata manager 222 uses metadata to determine which data files need to be accessed to retrieve data for processing a particular task or job. A monitor and workload analyzer 224 oversees processes performed by the compute service manager 106 and manages the distribution of tasks (e.g., workload) across the virtual warehouses and execution nodes in the execution platform 108. The monitor and workload analyzer 224 also redistributes tasks, as needed, based on changing workloads throughout the cloud computing platform 126 and may further redistribute tasks based on a user (e.g., “external”) query workload that may also be processed by the execution platform 108. The configuration and metadata manager 222 and the monitor and workload analyzer 224 are coupled to a data storage device 226. Data storage device 226 in FIG. 2 represents any data storage device within the storage platform 104. For example, data storage device 226 may represent buffers in execution platform 108, storage devices in cloud storage platform 104, or any other storage device.

As described in embodiments herein, the compute service manager 106 validates all communication from an execution platform (e.g., the execution platform 108) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1) may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

As shown, the compute service manager 106 includes the catalog link database component 130, which can enable the compute service manager 106 to implement one or more features for linking the network-based database system 102 to a catalog external to the network-based database system 102.

FIG. 3 is a block diagram 300 illustrating components of the execution platform 108, according to some example embodiments of the present disclosure. As shown in FIG. 3, the execution platform 108 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 108 can add new virtual warehouses and drop existing virtual warehouses in real-time based on the current processing needs of the systems and users. This flexibility allows the execution platform 108 to quickly deploy large amounts of computing resources when needed without being forced to continue paying for those computing resources when they are no longer needed. All virtual warehouses can access data from any data storage device (e.g., any storage device in storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 140-1 to 140-N shown in FIG. 1. Thus, the virtual warehouses are not necessarily assigned to a specific data storage device 140-1 to 140-N and, instead, can access data from any of the data storage devices 140-1 to 140-N within the storage platform 104. Similarly, each of the execution nodes shown in FIG. 3 can access data from any of the data storage devices 140-1 to 140-N. In some example embodiments, a particular virtual warehouse or a particular execution node can be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse N includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some example embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some example embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some example embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 108, the virtual warehouses can be implemented using multiple computing systems at multiple geographic locations. For example, virtual warehouse 1 can be implemented by a computing system at a first geographic location, while virtual warehouses 2 and N are implemented by another computing system at a second geographic location. In some example embodiments, these different computing systems are cloud-based computing systems maintained by one or more different entities.

Additionally, each virtual warehouse is shown in FIG. 3 as having multiple execution nodes. The multiple execution nodes associated with each virtual warehouse can be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 108 is also fault tolerant. For example, if one virtual warehouse fails, that virtual warehouse is quickly replaced with a different virtual warehouse at a different geographic location. A particular execution platform 108 may include any number of virtual warehouses. Additionally, the number of virtual warehouses in a particular execution platform is dynamic, such that new virtual warehouses are created when additional processing and/or caching resources are needed. Similarly, existing virtual warehouses can be deleted when the resources associated with the virtual warehouse are no longer useful.

In some example embodiments, the virtual warehouses may operate on the same data in storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

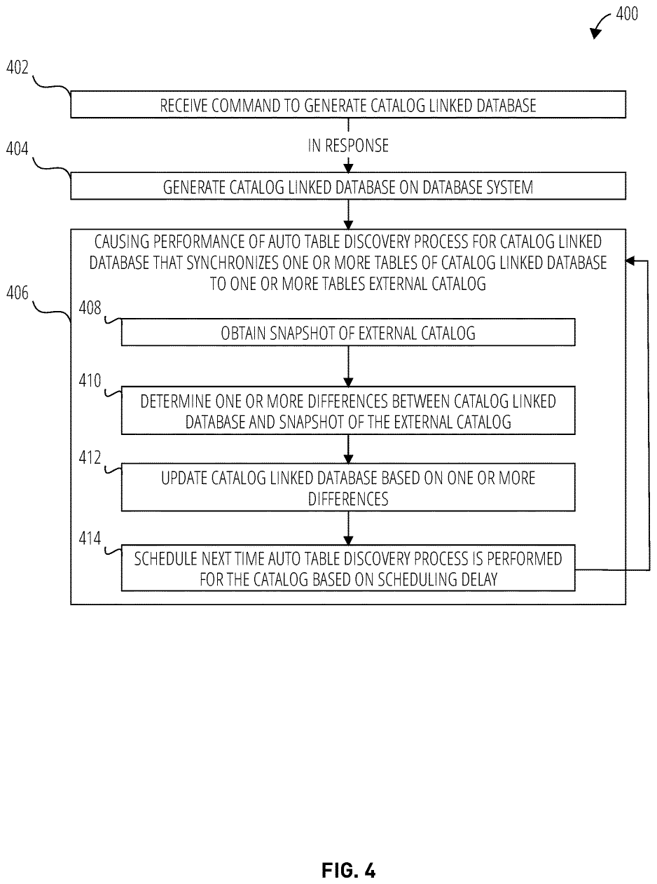

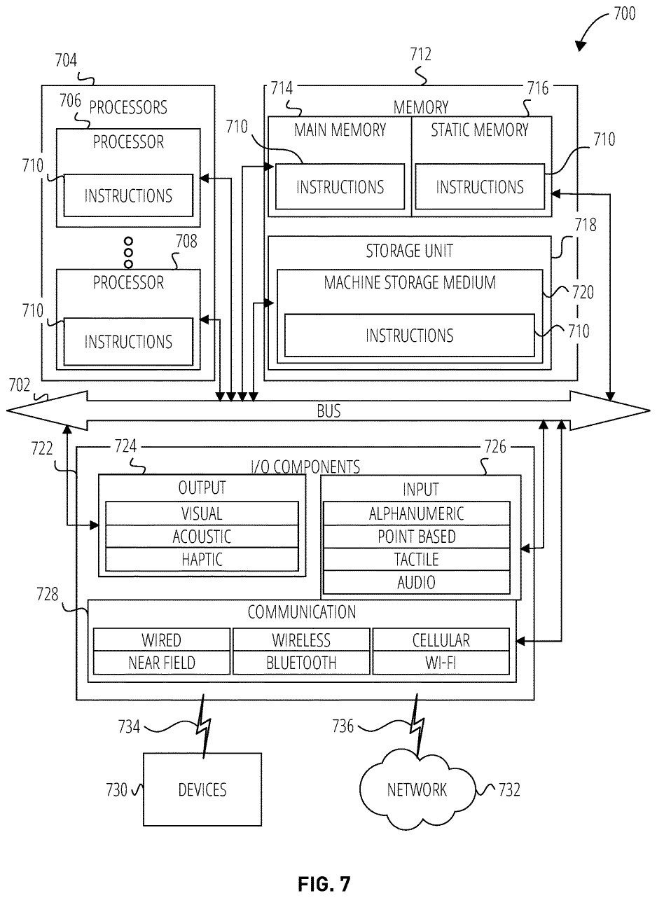

FIG. 4 is a flowchart of an example method 400 for linking a data system (e.g., a database system) to a catalog external to the data system, according to some example embodiments of the present disclosure. Method 400 may be embodied in computer-readable instructions for execution by one or more hardware components (e.g., one or more processors) such that the operations of method 400 can be performed by components of the storage platform 104 or the network-based database system 102, such as a network node (e.g., a network node of the compute service manager 106 executing the catalog link database component 130 of the network-based database system 102) or a computing device (e.g., client device 112), one or both of which may be implemented as machine 700 of FIG. 7 performing the disclosed functions. Accordingly, method 400 is described below, by way of example with reference thereto. However, it shall be appreciated that method 400 may be deployed on various other hardware configurations and is not intended to be limited to deployment within the network-based database system 102.

At operation 402, a processor (e.g., implementing the network-based database system 102) receives a command to generate a catalog linked database that links the database system to an external catalog that is external to the database system. Examples of commands received at operation 402 are presented in Table 2, Table 3, and Table 4 of the present disclosure.

In response, at operation 404, the processor generates the catalog linked database on the database system, where the catalog linked database operates on the database system as a representation of the external catalog. According to various example embodiments, the resulting catalog linked database is linked to the external catalog. To facilitate access to the external catalog, the catalog linked database can be generated with information (e.g., authentication credentials) for the external catalog that enables the catalog linked database to access the external catalog, where the information can be provided as part of the command received at operation 402 to create the catalog linked database. Alternatively, to facilitate access to the external catalog, the catalog linked database can be generated in association with (e.g., in connection with) a catalog integration that was generated on the database system (e.g., generated on the database system based on a command received by the database system prior to the command received at operation 402). An example of a command that generates a catalog integration is presented in Table 1 of the present disclosure.

At operation 406, the processor causes performance of an auto table discovery process for the catalog linked database, where the auto table discovery process synchronizes one or more tables of the catalog linked database to one or more tables of the external catalog. During the performance of the auto table discovery process, the processor performs one or more of operations 408 through 414.

During operation 408, the processor obtains a snapshot of the external catalog. For various example embodiments, the snapshot comprises at least one of a listing of namespaces of the external catalog or a listing of tables of the external catalog.

Thereafter, at operation 410, the processor determines one or more differences between the catalog linked database and the snapshot of the external catalog. For some example embodiments, operation 410 comprises the processor comparing at least one of namespaces or tables of the catalog linked database to the snapshot of the external catalog (e.g., to the listing of namespaces, to the listing of tables, or both). As part of this operation, the processor can determine correspondence between tables of catalog linked database and tables of external catalog based on unique table identifiers (e.g., table_uuid) associated with tables. Based on comparing the catalog linked database and the snapshot of the external catalog, the processor can determine whether a select table of the external catalog has been removed (e.g., dropped) from the external catalog. For example, the processor can compare tables of the catalog linked database to the snapshot of the external catalog by using unique table identifiers to determine a set of tables of the catalog linked database that corresponds to a set of tables of the external catalog, which can enable the processor to determine whether a select table of the external catalog has been removed from the external catalog by determining whether the select table is missing from the set of tables of the catalog linked database. Additionally, or alternatively, based on comparing the catalog linked database and the snapshot of the external catalog, the processor can determine whether a select table of the external catalog has been renamed on the external catalog. For instance, the processor can compare tables of the catalog linked database to the snapshot of the external catalog by using unique table identifiers to determine a set of tables of the catalog linked database that corresponds to a set of tables of the external catalog and by comparing a set of table names of the set of tables of the catalog linked database and a set of table names of the set of tables of the external catalog. In doing so, the processor can determine whether a name of the select table of the external catalog has changed based on the comparing of the set of table names of the set of tables of the catalog linked database and the set of table names of the set of tables of the external catalog.

Eventually, at operation 412, the processor updates the catalog linked database based on the one or more differences determined by the processor during operation 410. For various example embodiments, operation 412 comprises the processor generating a new schema in the catalog linked database that corresponds to a select schema of the external catalog in response to the one or more differences identifying that the select schema of the external catalog is missing in the catalog linked database. The select schema can comprise at least one of a namespace or a nested namespace. For various example embodiments, operation 412 comprises the processor generating a new table in the catalog linked database that corresponds to a select table of the external catalog in response to the one or more differences identifying that the select table of the external catalog is missing in the catalog linked database. The new table can comprise a table that is formatted in accordance with a specification of Apache Iceberg™. The select table can be associated with either a namespace or a nested namespace of the external catalog, and the new table can be generated in association with either a corresponding namespace or a corresponding nested namespace in the catalog linked database. For some example embodiments, the generation of the new table in the catalog linked database can comprise the processor scheduling creation of the new table in the catalog linked database and synchronization of data stored in the new table and in the select table (e.g., synchronization data stored in the new table with data stored in select table of the external catalog). For various example embodiments, operation 412 comprises the processor removing (e.g., dropping) a corresponding table from the catalog linked database that corresponds to a select table of external catalog in response to the processor determining (e.g., during operation 410) that the select table has been removed (e.g., dropped) from the external catalog. Further, for various example embodiments, operation 412 comprises the processor renaming a corresponding table of the catalog linked database that corresponds to a select table of the external catalog in response to determining that the select table has been renamed on the external catalog (e.g., rename the corresponding table to match the name of the select table).

At the end of the auto table discovery process, at operation 414, the processor schedules a next time the auto table discovery process is performed for the catalog linked database based on a scheduling delay. For instance, the processor can schedule the auto table discovery process to be performed at a (next) time determined based on a predetermined time interval or a dynamically-determined time interval. Additionally, after the auto table discovery process is performed at least once for the catalog linked database, the processor (e.g., of the network-based database system 102) can receive and process a command with respect to the catalog, such as a query command with respect to one or more tables of the catalog linked database. An example of this is illustrated by Table 7 of the present disclosure.

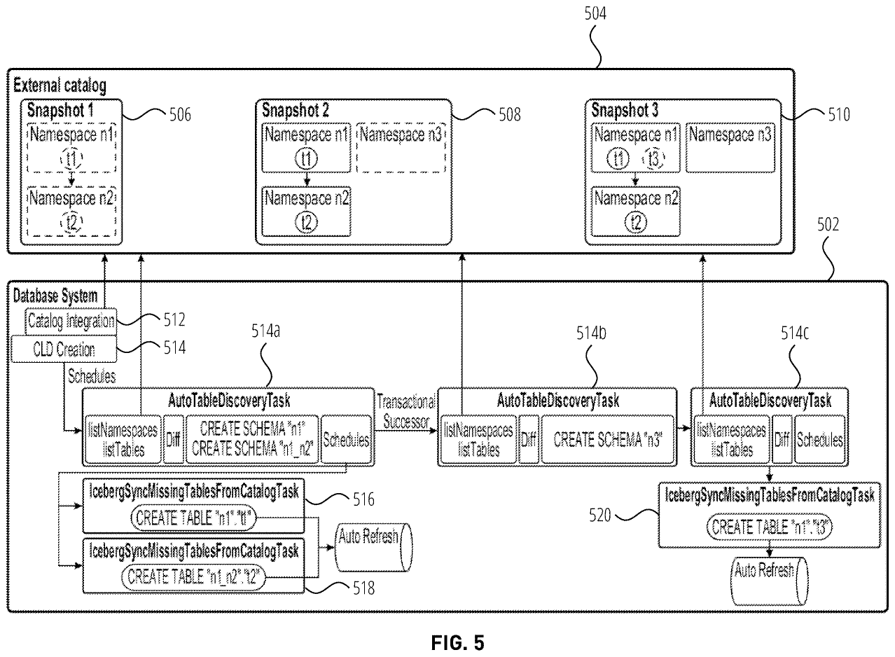

FIG. 5 is a diagram illustrating an example of linking and synchronizing of an external catalog and a database system 502, according to some example embodiments of the present disclosure. In particular, the diagram shows the interaction between an external catalog 504 and a database system 502. The external catalog 504 comprises multiple snapshots of the external catalog 504 (snapshot 1 506, snapshot 2 508, and snapshot 3 510), each of which represents the state of the remote catalog at different points in time.

According to snapshot 1 506, the external catalog 504 contains Namespace n1 with table t1 and Namespace n2 with table t2, where Namespace n2 is nested in Namespace n1. According to snapshot 2 508, a new Namespace n3 is added to the external catalog 504. Thereafter, according to snapshot 3 510, a new table t3 is added under Namespace n1, and a new Namespace n3 is added to the external catalog 504.

A catalog integration 512 is generated on the database system 502, where the catalog integration 512 connects to the database system 502 to the external catalog 504. Eventually, a CLD is generated (during a CLD creation process 514) on the database system 502, where the CLD is configured to use the catalog integration 512. The CLD creation process 514 can initiate (e.g., trigger) a series of auto table discovery process tasks (e.g., AutoTableDiscoveryTask)—auto table discovery process task 514a, auto table discovery process task 514b that succeeds auto table discovery process task 514a, and auto table discovery process task 514c that succeeds auto table discovery process task 514b. Each auto table discovery process task calls the listNamespaces and listTables APIs on the external catalog 504 to obtain a snapshot of namespaces and tables of the external catalog 504, and performs a difference (diff) operation to compare the resulting information (listing of namespaces and listing of tables) with the existing namespaces and tables in the CLD and to identify one or more differences.

Based on the differences detected, the database system 502 creates schemas in the CLD corresponding to namespaces found in the external catalog 504. For example, during the auto table discovery process task 514a, the database system 502 creates schema “n1” (for Namespace n1) in the CLD and schema “n1_n2” (for Namespace n2) in the CLD based on snapshot 1 506, and during the auto table discovery process task 514b, the database system 502 creates a schema “n3” (for Namespace n3) based on snapshot 2 508.

For each new table found in the external catalog 504, the database system 502 schedules a table synchronization task (e.g., IcebergSyncMissingTablesFromCatalogTask) to create the table in the CLD. The table synchronization tasks scheduled are represented by table synchronization task 516, table synchronization task 518, table synchronization task 520 in FIG. 5, where table synchronization task 516 creates table t1 under schema “n1” of the CLD (based on snapshot 1 506) and table synchronization task 518 creates table t2 under schema “n1_n2” of the CLD (based on snapshot 1 506), and where table synchronization task 520 creates table t3 under schema “n3” of the CLD (based on snapshot 3 510). According to various example embodiments, these tasks create Iceberg tables (e.g., unmanaged Iceberg tables) in the CLD that point to the corresponding tables in the external catalog 504.

Overall, FIG. 5 shows how changes in the external catalog 504 propagate to the CLD over time. When Namespace n3 appears in snapshot 2 508, the next auto table discovery process task 514b creates a corresponding schema in the CLD. When table t3 appears under Namespace n1 in snapshot 3 510, the database system 502 schedules table synchronization task 520 to create the table in the CLD. Depending on the example embodiment, auto table discovery process tasks can run on a scheduled basis, where each task can schedule its transactional successor to continue monitoring the external catalog 504 for changes. For some example embodiments, each table created in the CLD have auto-refresh enabled, which allows them to stay synchronized with corresponding tables of the external catalog 504.

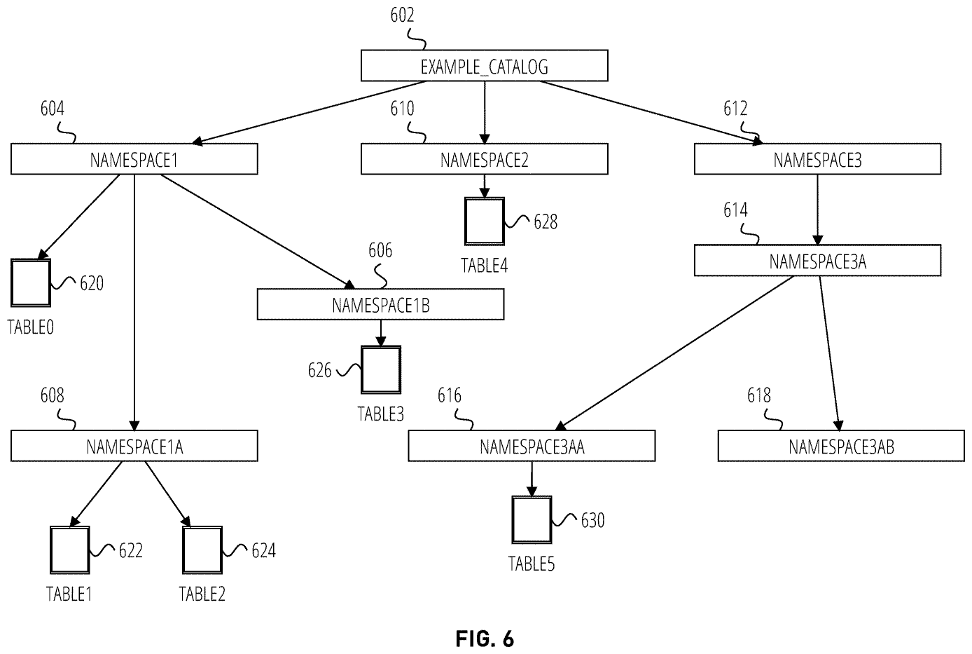

FIG. 6 is a hierarchical diagram illustrating an example namespace and table structure within an example external catalog 602, according to some example embodiments of the present disclosure. The diagram depicts external catalog 602 “EXAMPLE_CATALOG” at the top level, which serves as the root container for all namespaces and tables in the external catalog. From the external catalog 602, multiple namespaces branch out, including NAMESPACE1 604, NAMESPACE2 610, and NAMESPACE3 612. NAMESPACE1 604 includes both a TABLE0 620 and nested namespaces NAMESPACE1B 606 and NAMESPACE1A 608. NAMESPACE1A 608 comprises TABLE1 622 and TABLE2 624, while NAMESPACE1B 606 comprises TABLE3 626. NAMESPACE2 610 comprises TABLE4 628, showing a direct table relationship without nested namespaces. NAMESPACE3 612 branches to a nested namespace NAMESPACE3A 614, which further comprises two nested namespaces: NAMESPACE3AA 616 and NAMESPACE3AB 618. NAMESPACE3AA 616 comprises TABLE5 630. Where a database system is configured to handle nested namespaces and use delimiter “/”, all namespaces and tables are created in the catalog linked database, but nested namespaces are flattened using the specified delimiter. For example, TABLE5 630 can be created in a CLD of the database system under a schema Namespace3/Namespace3A/Namespace3AB.

FIG. 7 illustrates a diagrammatic representation of a machine 700 in the form of a computer system within which a set of instructions can be executed for causing the machine 700 to perform any one or more of the methodologies discussed herein, according to some example embodiments of the present disclosure. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein can be executed. For example, the instructions 710 may cause the machine 700 to execute any one or more operations of any one or more of the methods described herein. As another example, the instructions 710 may cause the machine 700 to implement portions of the data flows described herein. In this way, the instructions 710 transform a general, non-programmed machine into a particular machine 700 (e.g., the compute service manager 106, the execution platform 108, client device 112) that is specially configured to carry out any one of the described and illustrated functions in the manner described herein.

In alternative embodiments, the machine 700 operates as a standalone device or can be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 710, sequentially or otherwise, that specify actions to be taken by the machine 700. Further, while only a single machine 700 is illustrated, the term “machine” shall also be taken to include a collection of machines machine 700 that individually or jointly execute the instructions 710 to perform any one or more of the methodologies discussed herein.

The machine 700 includes processors 704, memory 712, and input/output (I/O) components 722 configured to communicate with each other such as via a bus 702. In an example embodiment, the processors 704 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 706 and a processor 708 that may execute the instructions 710. The term “processor” is intended to include multi-core processors 704 that may comprise two or more independent processors (sometimes referred to as “cores”) that may execute instructions 710 contemporaneously. Although FIG. 7 shows multiple processors 704, the machine 700 may include a single processor with a single core, a single processor with multiple cores (e.g., a multi-core processor), multiple processors with a single core, multiple processors with multiple cores, or any combination thereof.

The memory 712 may include a main memory 714, a static memory 716, and a storage unit 718, all accessible to the processors 704 such as via the bus 702. The main memory 714, the static memory 716, and the storage unit 718 comprising a machine storage medium 720 may store the instructions 710 embodying any one or more of the methodologies or functions described herein. The instructions 710 may also reside, completely or partially, within the main memory 714, within the static memory 716, within the storage unit 718, within at least one of the processors 704 (e.g., within the processor's cache memory), or any suitable combination thereof, during execution thereof by the machine 700.

The I/O components 722 include components to receive input, provide output, produce output, transmit information, exchange information, capture measurements, and so on. The specific I/O components 722 that are included in a particular machine 700 will depend on the type of machine. For example, portable machines such as mobile phones will likely include a touch input device or other such input mechanisms, while a headless server machine will likely not include such a touch input device. It will be appreciated that the I/O components 722 may include many other components that are not shown in FIG. 7. The I/O components 722 are grouped according to functionality merely for simplifying the following discussion and the grouping is in no way limiting. In various example embodiments, the I/O components 722 may include output components 724 and input components 726. The output components 724 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication can be implemented using a wide variety of technologies. The I/O components 722 may include communication components 728 operable to couple the machine 700 to a network 732 via a coupling 736 or to devices 730 via a coupling 734. For example, the communication components 728 may include a network interface component or another suitable device to interface with the network 732. In further examples, the communication components 728 may include wired communication components, wireless communication components, cellular communication components, and other communication components to provide communication via other modalities. The devices 730 can be another machine or any of a wide variety of peripheral devices (e.g., a peripheral device coupled via a universal serial bus (USB)). For example, as noted above, the machine 700 may correspond to any client device, the compute service manager 106, the execution platform 108, and the devices 730 may include any other of these systems and devices.

The various memories (e.g., 712, 714, 716, and/or memory of the processor(s) 704 and/or the storage unit 718) may store one or more sets of instructions 710 and data structures (e.g., software) embodying or utilized by any one or more of the methodologies or functions described herein. These instructions 710, when executed by the processor(s) 704, cause various operations to implement the disclosed embodiments.

As used herein, the terms “machine-storage medium,” “device-storage medium,” and “computer-storage medium” mean the same thing and can be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 732 can be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 732 or a portion of the network 732 may include a wireless or cellular network, and the coupling 736 can be a Code Division Multiple Access (CDMA) connection, a Global System for Mobile communications (GSM) connection, or another type of cellular or wireless coupling. In this example, the coupling 736 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 710 can be transmitted or received over the network 732 using a transmission medium via a network interface device (e.g., a network interface component included in the communication components 728) and utilizing any one of a number of well-known transfer protocols (e.g., hypertext transfer protocol (HTTP)). Similarly, the instructions 710 can be transmitted or received using a transmission medium via the coupling 734 (e.g., a peer-to-peer coupling) to the devices 730. The terms “transmission medium” and “signal medium” mean the same thing and can be used interchangeably in this disclosure. The terms “transmission medium” and “signal medium” shall be taken to include any intangible medium that is capable of storing, encoding, or carrying the instructions 710 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other example embodiments the processors may be distributed across several locations.

Described implementations of the subject matter can include one or more features, alone or in combination as illustrated below by way of examples.

Example 1 is a database system comprising: at least one processor; and at least one memory storing instructions that cause the at least one processor to perform operations comprising: receiving a command to generate a catalog linked database that links the database system to an external catalog that is external to the database system; and in response to the command: generating the catalog linked database on the database system, the catalog linked database operating on the database system as a representation of the external catalog; and causing performance of an auto table discovery process for the catalog linked database that synchronizes one or more tables of the catalog linked database to one or more tables of the external catalog, the auto table discovery process comprising: obtaining a snapshot of the external catalog, the snapshot comprising at least one of a listing of namespaces of the external catalog or a listing of tables of the external catalog; determining one or more differences between the catalog linked database and the snapshot of the external catalog; and updating the catalog linked database based on the one or more differences.

In Example 2, the subject matter of Example 1 includes, wherein the updating of the catalog linked database based on the one or more differences comprises: in response to the one or more differences identify a select schema of the external catalog that is missing in the catalog linked database, generating a new schema in the catalog linked database that corresponds to the select schema.

In Example 3, the subject matter of Example 2 includes, wherein the select schema comprises at least one of a namespace or a nested namespace.

In Example 4, the subject matter of Examples 1-3 includes, wherein the updating of the catalog linked database based on the one or more differences comprises: in response to the one or more differences identifying a select table of the external catalog that is missing in the catalog linked database, generating a new table in the catalog linked database that corresponds to the select table.

In Example 5, the subject matter of Example 4 includes, wherein the select table is associated with either a namespace or a nested namespace of the external catalog, and wherein the new table is generated in association with either a corresponding namespace or a corresponding nested namespace.

In Example 6, the subject matter of Examples 4-5 includes, wherein the generating of the new table in the catalog linked database that corresponds to the select table comprises: scheduling creation of the new table in the catalog linked database and synchronization of data stored in the new table and in the select table.

In Example 7, the subject matter of Examples 4-6 includes, wherein the new table comprises a table that is formatted in accordance with a specification of Apache Iceberg™.

In Example 8, the subject matter of Examples 1-7 includes, wherein the determining of the one or more differences between the catalog linked database and the snapshot of the external catalog comprises: comparing at least one of namespaces or tables of the catalog linked database to the snapshot of the external catalog; and based on the comparing of the catalog linked database and the snapshot of the external catalog, determining whether a select table of the external catalog has been removed from the external catalog, the updating of the catalog linked database based on the one or more differences comprising: removing a corresponding table from the catalog linked database that corresponds to the select table in response to determining that the select table has been removed.

In Example 9, the subject matter of Example 8 includes, wherein the comparing of the catalog linked database to the snapshot of the external catalog comprises: using unique table identifiers to determine a set of tables of the catalog linked database that corresponds to a set of tables of the external catalog, the determining of whether the select table of the external catalog has been removed from the external catalog comprising: determining whether the select table is missing from the set of tables of the catalog linked database.

In Example 10, the subject matter of Examples 1-9 includes, wherein the determining of the one or more differences between the catalog linked database and the snapshot of the external catalog comprises: comparing at least one of namespaces or tables of the catalog linked database to the snapshot of the external catalog; and based on the comparing of the catalog linked database and the snapshot of the external catalog, determining whether a select table of the external catalog has been renamed on the external catalog, the updating of the catalog linked database based on the one or more differences comprising: renaming a corresponding table from the catalog linked database that corresponds to the select table in response to determining that the select table has been renamed.

In Example 11, the subject matter of Example 10 includes, wherein the comparing of the catalog linked database to the snapshot of the external catalog comprises: using unique table identifiers to determine a set of tables of the catalog linked database that corresponds to a set of tables of the external catalog; and comparing a set of table names of the set of tables of the catalog linked database and a set of table names of the set of tables of the external catalog, the determining of whether the select table of the external catalog has been removed from the external catalog comprising: determining whether a name of the select table of the external catalog has changed based on the comparing of the set of table names of the set of tables of the catalog linked database and the set of table names of the set of tables of the external catalog.

In Example 12, the subject matter of Examples 1-11 includes, wherein the auto table discovery process comprises: at an end of the auto table discovery process, scheduling a next time the auto table discovery process is performed for the catalog based on a scheduling delay.

Example 13 is a method to implement any of Examples 1-12.

Example 14 is a machine-storage medium storing instructions that when executed by a machine, cause the machine to perform operations to implement any of Examples 1-12.

Although the example embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other example embodiments may be used and derived therefrom, such that structural and logical substitutions and changes may be made without departing from the scope of this disclosure. This Detailed Description, therefore, is not to be taken in a limiting sense, and the scope of various example embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various example embodiments. Combinations of the above embodiments, and other example embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A database system comprising:
at least one processor; and
at least one memory storing instructions that cause the at least one processor to perform operations comprising:
receiving a command to generate a catalog linked database that links the database system to an external catalog that is external to the database system; and
in response to the command:
generating the catalog linked database on the database system, the catalog linked database operating on the database system as a representation of the external catalog; and
causing performance of an auto table discovery process for the catalog linked database that synchronizes one or more tables of the catalog linked database to one or more tables of the external catalog, the auto table discovery process comprising:
obtaining a snapshot of the external catalog, the snapshot comprising at least one of a listing of namespaces of the external catalog or a listing of tables of the external catalog;
determining one or more differences between the catalog linked database and the snapshot of the external catalog; and
updating the catalog linked database based on the one or more differences.

2. The database system of claim 1, wherein the updating of the catalog linked database based on the one or more differences comprises:
in response to the one or more differences identify a select schema of the external catalog that is missing in the catalog linked database, generating a new schema in the catalog linked database that corresponds to the select schema.

3. The database system of claim 2, wherein the select schema comprises at least one of a namespace or a nested namespace.

4. The database system of claim 1, wherein the updating of the catalog linked database based on the one or more differences comprises:
in response to the one or more differences identifying a select table of the external catalog that is missing in the catalog linked database, generating a new table in the catalog linked database that corresponds to the select table.

5. The database system of claim 4, wherein the select table is associated with either a namespace or a nested namespace of the external catalog, and wherein the new table is generated in association with either a corresponding namespace or a corresponding nested namespace.

6. The database system of claim 4, wherein the generating of the new table in the catalog linked database that corresponds to the select table comprises:
scheduling creation of the new table in the catalog linked database and synchronization of data stored in the new table and in the select table.

7. The database system of claim 4, wherein the new table comprises a table that is formatted in accordance with a specification of A pache Iceberg.

8. The database system of claim 1, wherein the determining of the one or more differences between the catalog linked database and the snapshot of the external catalog comprises:
comparing at least one of namespaces or tables of the catalog linked database to the snapshot of the external catalog; and
based on the comparing of the catalog linked database and the snapshot of the external catalog, determining whether a select table of the external catalog has been removed from the external catalog, the updating of the catalog linked database based on the one or more differences comprising:
removing a corresponding table from the catalog linked database that corresponds to the select table in response to determining that the select table has been removed.

9. The database system of claim 8, wherein the comparing of the catalog linked database to the snapshot of the external catalog comprises:
using unique table identifiers to determine a set of tables of the catalog linked database that corresponds to a set of tables of the external catalog, the determining of whether the select table of the external catalog has been removed from the external catalog comprising:
determining whether the select table is missing from the set of tables of the catalog linked database.

10. The database system of claim 1, wherein the determining of the one or more differences between the catalog linked database and the snapshot of the external catalog comprises:
comparing at least one of namespaces or tables of the catalog linked database to the snapshot of the external catalog; and
based on the comparing of the catalog linked database and the snapshot of the external catalog, determining whether a select table of the external catalog has been renamed on the external catalog, the updating of the catalog linked database based on the one or more differences comprising:
renaming a corresponding table from the catalog linked database that corresponds to the select table in response to determining that the select table has been renamed.

11. The database system of claim 10, wherein the comparing of the catalog linked database to the snapshot of the external catalog comprises:
using unique table identifiers to determine a set of tables of the catalog linked database that corresponds to a set of tables of the external catalog; and
comparing a set of table names of the set of tables of the catalog linked database and a set of table names of the set of tables of the external catalog, the determining of whether the select table of the external catalog has been removed from the external catalog comprising:
determining whether a name of the select table of the external catalog has changed based on the comparing of the set of table names of the set of tables of the catalog linked database and the set of table names of the set of tables of the external catalog.

12. The database system of claim 1, wherein the auto table discovery process comprises:
at an end of the auto table discovery process, scheduling a next time the auto table discovery process is performed for the catalog based on a scheduling delay.

13. A method comprising:
receiving, by at least one processor, a command to generate a catalog linked database that links a database system to an external catalog that is external to the database system; and
in response to the command:
generating, by the at least one processor, the catalog linked database on the database system, the catalog linked database operating on the database system as a representation of the external catalog; and
causing, by the at least one processor, performance of an auto table discovery process for the catalog linked database that synchronizes one or more tables of the catalog linked database to one or more tables of the external catalog, the auto table discovery process comprising:
obtaining a snapshot of the external catalog, the snapshot comprising at least one of a listing of namespaces of the external catalog or a listing of tables of the external catalog;
determining one or more differences between the catalog linked database and the snapshot of the external catalog; and
updating the catalog linked database based on the one or more differences.

14. The method of claim 13, wherein the updating of the catalog linked database based on the one or more differences comprises:
in response to the one or more differences identify a select schema of the external catalog that is missing in the catalog linked database, generating a new schema in the catalog linked database that corresponds to the select schema.

15. The method of claim 13, wherein the updating of the catalog linked database based on the one or more differences comprises:
in response to the one or more differences identifying a select table of the external catalog that is missing in the catalog linked database, generating a new table in the catalog linked database that corresponds to the select table.

16. The method of claim 13, wherein the determining of the one or more differences between the catalog linked database and the snapshot of the external catalog comprises:
comparing at least one of namespaces or tables of the catalog linked database to the snapshot of the external catalog; and
based on the comparing of the catalog linked database and the snapshot of the external catalog, determining whether a select table of the external catalog has been removed from the external catalog, the updating of the catalog linked database based on the one or more differences comprising:
removing a corresponding table from the catalog linked database that corresponds to the select table in response to determining that the select table has been removed.

17. The method of claim 13, wherein the determining of the one or more differences between the catalog linked database and the snapshot of the external catalog comprises:
comparing at least one of namespaces or tables of the catalog linked database to the snapshot of the external catalog; and
based on the comparing of the catalog linked database and the snapshot of the external catalog, determining whether a select table of the external catalog has been renamed on the external catalog, the updating of the catalog linked database based on the one or more differences comprising:
renaming a corresponding table from the catalog linked database that corresponds to the select table in response to determining that the select table has been renamed.

18. The method of claim 13, wherein the auto table discovery process comprises:
at an end of the auto table discovery process, scheduling a next time the auto table discovery process is performed for the catalog based on a scheduling delay.

19. A machine-storage medium storing instructions that when executed by a machine, cause the machine to perform operations comprising:
receiving a command to generate a catalog linked database that links a database system to an external catalog that is external to the database system; and
in response to the command:
generating the catalog linked database on the database system, the catalog linked database operating on the database system as a representation of the external catalog; and
causing performance of an auto table discovery process for the catalog linked database that synchronizes one or more tables of the catalog linked database to one or more tables of the external catalog, the auto table discovery process comprising:
obtaining a snapshot of the external catalog, the snapshot comprising at least one of a listing of namespaces of the external catalog or a listing of tables of the external catalog;
determining one or more differences between the catalog linked database and the snapshot of the external catalog, the determining of the one or more differences comprising comparing at least one of namespaces or tables of the catalog linked database to the snapshot of the external catalog; and
updating the catalog linked database based on the one or more differences.

20. The machine-storage medium storing instructions of claim 19, wherein the updating of the catalog linked database based on the one or more differences comprises:
in response to the one or more differences identifying a select table of the external catalog that is missing in the catalog linked database, generating a new table in the catalog linked database that corresponds to the select table.
